(19) United States
(12) Patent Application Publication
(10) Pub. No.: US 2013/0230603 A1
(43) Pub. Date: Sep. 5, 2013

(54) Polyheterosilxoanes For Antimicrobial Materials

(71) Applicants: Nanguo Liu, Midland, MI (US); Shawn Keith Mealey, Midland, MI (US)

(72) Inventors: Nanguo Liu, Midland, MI (US); Shawn Keith Mealey, Midland, MI (US)

(73) Assignee: Dow Corning Corporation, Midland, MI (US)

(21) Appl. No.: 13/885,702

(22) PCT Filed: Jan. 5, 2012
(86) PCT No.: PCT/US2012/020276

§ 371 Date: May 16, 2013

Related U.S. Application Data
(60) Provisional application No. 61/429,973, filed on Jan. 5, 2011.

(51) Int. Cl. A01N 25/10

(52) U.S. Cl. CPC A01N 25/10
USPC 424/618; 424/617

(57) ABSTRACT

Polyheterosiloxane compositions are disclosed containing at least 70% by weight of the following components: (A) a first metal (M1) selected from Ti, Zr, or Zn, (B) a second metal (M2), Zn, Cu, Bi, or Ag with the proviso that the second metal is not the same as the first metal, (C) siloxy units having the formula R′₂SiO_{2/2} or R′SiO_{3/2} where R′ is independently a hydrocarbon group or halogen substituted hydrocarbon group containing 1 to 18 carbon atoms. The disclosed compositions are useful to prepare antimicrobial materials.

### CROSS-REFERENCE TO RELATED APPLICATIONS

This application claims the benefit of U.S. Patent Application No. 61/429,973, as filed on 5 Jan., 2011.

### BACKGROUND OF THE INVENTION

Antimicrobial materials are of particular interest for a wide variety of applications. Many metals such as tin, zinc, or silver are known for the antimicrobial properties. There is a continuing need to identify compositions and methods for incorporating such metals into surfaces to render them antimicrobial, yet minimize or eliminate the leaching of the metal from the surface during use.

### BRIEF SUMMARY OF THE INVENTION

The present inventors have discovered certain polyheterosiloxane compositions that are useful to render surfaces antimicrobial. The polyheterosiloxane compositions comprise at least 70% by weight of:

(A) a first metal (M1) selected from Ti, Zr, or Zn,

(B) a second metal (M2), selected from Zn, Cu, Bi, or Ag
with the proviso that the second metal is not the same as the first metal,

(C) siloxy units having the formula R¹₂SiO_{2/2} or R¹SiO_{3/2}
where R¹ is independently a hydrocarbon group or halogen substituted hydrocarbon group containing 1 to 30 carbon atoms,
   wherein;

the mole fraction of components (A), (B), and (C) in the polyheterosiloxane composition relative to each other is of the formula [M1]ₐ[M2]_{b}[R¹₂SiO_{2/2}]_{c} [R¹SiO_{3/2}]_{d}
where
   a may vary from 0.10 to 0.7,
   b may vary from 0.001 to 0.5,
   c may vary from zero to 0.9,
   d may vary from zero to 0.9,
with the provisos that c and d both cannot be zero,
   and the sum of a+b+c+d≈1,

the polyheterosiloxane composition is soluble in an aromatic hydrocarbon solvent.

The polyheterosiloxane compositions may be used to prepare durable antimicrobial surfaces.

### DETAILED DESCRIPTION OF THE INVENTION

The polyheterosiloxane compositions of the present invention contain at least 70% by weight of the following components:

(A) a first metal (M1) selected from Ti, Zr, or Zn,

(B) a second metal (M2), selected from Zn, Cu, Bi, or Ag
with the proviso that the second metal is not the same as the first metal,

(C) siloxy units having the formula R′₂SiO_{2/2} or R′SiO_{3/2}

each of which are described in detail as follows.

### (A) The First Metal (M1)

Component (A) of the polyheterosiloxane composition is a first metal described by M1 which may be selected from all non-lanthanide metals in the Periodic Table of Elements, providing the metal selected for M1 is different from the second metal (M2). Alternatively, M1 is Ti, Zr, Zn, or any combination thereof. Alternatively, M1 is Ti.

The oxidation state of M1 may independently range from 1 to 7. Alternatively, the oxidation state of M1 independently ranges from 1 to 5. M1 in the polyheterosiloxane compositions may have the same or different oxidation states.

In the polyheterosiloxane compositions, M1 may be bonded to other M1 components, M2 components, and/or other various organopolysiloxane segments. When bonded to other M1 or M2 components, the metals may be linked via oxygen, such as M1-O-M2.

Besides having bonds to components (A), (B) or (C), M1 may have a variety of substituents bonded to it in the present polyheterosiloxane compositions. These substitutes may be residual or un-reacted substituents present on the metal atom in the starting compound used to prepare the polyheterosiloxane, which is discussed below. The amount of M1 present in the polyheterosiloxane compositions may vary, providing the amounts are within the mole fractions as detailed below.

### (B) The Second Metal (M2)

Component (B) of the polyheterosiloxane composition is a second metal described by M2 which may be selected from Zn, Ag, Bi, Cu, or any combination thereof, providing M2 is not the same as Ml.

The oxidation state of M2 may independently range from 1 to 7. Alternatively, the oxidation state of M2 independently ranges from 1 to 5. M2 in the polyheterosiloxane compositions may have the same or different oxidation states.

In the polyheterosiloxane compositions, M2 may be bonded to other M1 components, M2 components, and/or other various organopolysiloxane segments. When bonded to other M1 or M2 components, the metals may be linked via oxygen, such as M1-O-M2.

Besides having bonds to components (A), (B), or (C), M2 may have a variety of substituents bonded to it in the present polyheterosiloxane compositions. These substitutes may be residual or un-reacted substituents present on the metal atom in the starting compound used to prepare the polyheterosiloxane, which is discussed below.

The amount of M2 present in the polyheterosiloxane compositions may vary, providing the amounts are within the mole fractions as detailed below.

(C) Siloxy Units having the Formula R₂SiO_{2/2} or RSiO_{3/2}

The polyheterosiloxane compositions of the present invention contain at least some portion that may be considered as organopolysiloxane segments. Organopolysiloxanes are polymers containing siloxy units independently selected from (R₃SiO_{1/2}), (R₂SiO_{2/2}), (RSiO_{3/2}), or (SiO_{4/2}) siloxy units, where R may be any monovalent organic group, alternatively R is a hydrocarbon group containing 1 to 18 carbons, alternatively R is an alkyl group containing 1 to 12 carbon atoms, or alternatively R is methyl or phenyl. These siloxy units are commonly referred to as M, D, T, and Q units respectively. Their molecular structures are listed below:

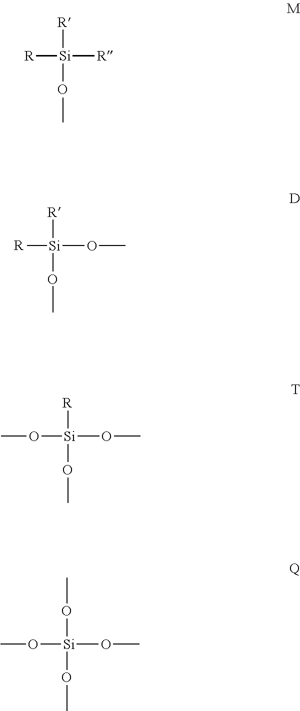

These siloxy units can be combined in various manners to form cyclic, linear, or branched structures. The chemical and physical properties of the resulting polymeric structures vary depending on the number and type of siloxy units in the organopolysiloxane.

The polyheterosiloxane compositions of the present invention contain organopolysiloxane segments composed of D or T siloxy units, that is siloxy units having the formula R′₂SiO_{2/2} or R′SiO_{3/2}. The organopolysiloxane segments may contain other siloxy units, that is any combination of M, D, T, or Q siloxy units, providing at least one D or T unit is present in the organopolysiloxane having the formula R′₂SiO_{2/2} or R′SiO_{3/2}. In these siloxy formulae, R′ is independently a hydrocarbon group or halogen substituted hydrocarbon group containing 1 to 18 carbon atoms. These hydrocarbon groups may have from 1 to 18 carbon atoms, alternatively from 1 to 12 carbon atoms, and are exemplified by, but not limited to alkyl groups such as methyl, ethyl, propyl, butyl, pentyl, hexyl, heptyl, octyl, undecyl, and octadecyl; cycloalkyl such as cyclohexyl; aryl such as phenyl, tolyl, xylyl, benzyl, and 2-phenylethyl; and halogenated hydrocarbon groups such as 3,3,3-trifluoropropyl, 3-chloropropyl, and dichlorophenyl.

The number of siloxy units present in any given organopolysiloxane segment of the polyheterosiloxane composition may vary, providing the amounts are within the mole fractions as detailed below. The number and type of siloxy units present will affect the molecular weight of the organopolysiloxane segment, and hence the molecular weight of the polyheterosiloxanes.

In one embodiment, the organopolysiloxane segments of the polyheterosiloxane composition are composed primarily of R′SiO_{3/2} siloxy units where R′ is phenyl.

In another embodiment, the organopolysiloxane segments of the polyheterosiloxane composition are composed primarily of R′₂SiO_{2/2} siloxy units where one R′ substituent is phenyl, and the other R′ substituent is methyl.

In another embodiment, the organopolysiloxane segments of the polyheterosiloxane composition is composed primarily of a combination of R′₂SiO_{2/2} and R′SiO_{3/2}siloxy units where one R′ substituent in the R′₂SiO_{2/2} siloxy unit is phenyl, and the other R′ substituent is methyl, R′ is phenyl in the R′SiO_{3,2} siloxy unit.

The polyheterosiloxane compositions of the present invention contain at least 70%, alternatively 80%, alternatively 90%, alternatively 95%, or alternatively 98% by weight of components (A), (B), and (C) as described above.

The amount of components (A), (B), and (C) in the present polyheterosiloxane compositions may vary. For purposes of the present invention, the varied amounts of each is described by defining the mole fractions of each component relative to the total number of moles of components (A), (B), and (C) present in the polyheterosiloxane composition. Thus, the mole fraction of components (A), (B), and (C) in the polyheterosiloxane composition relative to each other is of the formula [M1]ₐ[M2]_{b}[R′₂SiO_{2/2}]_{c} [R′SiO_{3/2}]_{d}
where a may vary from 0.010 to 0.7,
   alternatively from 0.1 to 0.6,
   alternatively from 0.2 to 0.5,
b may vary from 0.001 to 0.5,
   alternatively from 0.01 to 0.3,
   alternatively from 0.05 to 0.25,
c may vary from zero to 0.9,
   alternatively from 0.1 to 0.6,
   alternatively from 0.2 to 0.5,
d may vary from zero to 0.9,
   alternatively from 0.1 to 0.5,
   alternatively from 0.1 to 0.3,
with the provisos that c and d both cannot be zero, and the sum of a+b+c+d≈1.

The terminology “≈” describes that the sum of a+b+c+d is approximately equal to 1. For example, in various embodiments, the sum may be 0.99, 0.98, 0.97, 0.96, 0.95, etc. If the sum does not equal 1, then the polyheterosiloxane composition may include residual amounts of groups that are not described by the aforementioned formula.

The number of moles of each component in the polyheterosiloxane composition may be determined using common analytical techniques. The number of moles of both M1 and M2 in the polyheterosiloxane composition may be determined using common elemental analysis techniques. The number of moles of the siloxy units may be determined by ²⁹Si NMR. Alternatively, the number of moles of each component may be calculated from the amounts of each used in the process to prepare the polyheterosiloxane, and accounting for any losses (such as removal of volatile species) that may occur during the process to produce the polyheterosiloxane.

While not being limited to any theory, the present inventors believe the polyheterosiloxane compositions to be composed of a complex mixture of various heterosiloxane structures. It is believed that the polyheterosiloxane compositions contain various polymeric structures with Si—O—Si, Si—O-M1, M1-O-M1, and M1-O-M2 linkages as well as Si—O-M2 and M2-O-M2 linkages. However, the concentration of metal to metal links (M1-O-M1, M1-O-M2, M2-O-M2) are controlled so as to prevent the formation of metal aggregates or particles of sufficient size to either render the polyheterosiloxanes insoluble in organic solvents, or are of insufficient size to be detected using TEM techniques. Residual alkoxide (—OR) groups also exist on polyheterosiloxane structures and are mainly bonded to M1 and Si, as evidenced by ²⁹Si and ¹³C NMR and the solubility of the present polyheterosiloxane compositions in an aromatic solvent. The present polyheterosiloxanes may contain from 1% to 20% by weight alkoxy groups, alternatively, from 5% to 15% by weight alkoxy groups. Residual counter ions from the metal salts (M2) may also be present and are believed to be bonded or chelated to M1 and M2.

The present polyheterosiloxane compositions are typically soluble in many organic solvents. In particular, the present polyheterosiloxane compositions are soluble in an aromatic hydrocarbon solvent. As used herein, “soluble” means the present polyheterosiloxane compositions dissolve in toluene to form a homogeneous solution having a concentration of at least 1 weight percent of the polyheterosiloxane at 23° C., alternatively having a concentration of at least 5 weight percent of the polyheterosiloxane in toluene at 23° C., alternatively having a concentration of at least 10 weight percent of the polyheterosiloxane in toluene at 23° C., alternatively having a concentration of at least 20 weight percent of the polyheterosiloxane in toluene at 23° C. The present polyheterosiloxane compositions may also be soluble in other organic solvents, such as chloroform, carbon tetrachloride, THF, and butyl acetate.

The polyheterosiloxanes have molecular weights (weight average) ranging from 1000 to 1,000,000 g/mole, alternatively from 2,000 to 400,000 g/mole, alternatively from 2,000 to 200,000 g/mole. The molecular weights may be determined using modified GPC techniques to eliminate possible interactions between the sample and the column system. For example, the molecular weights may be determined by GPC analysis using triple detectors (light scattering, refractometer, and viscometer) with a column (PL 5u 100a 100×7.8 mm) designed for rapid analysis or Flow Injection Polymer Analysis (FIPA).

The present polyheterosiloxane compositions may include “metal-rich” domains and “siloxane-rich” domains. As used herein “metal-rich” domains describes the structural segments of the polyheterosiloxane compositions where a plurality of linking bonds contain M1 or M2 (that is M1-O-M1, M1-O-M2, M2-O-M2, M1-O—Si, or M2-O—Si). As used herein “siloxane-rich” refers to the structural segments of the polyheterosiloxane compositions where a plurality of linking bonds are siloxane (Si—O—Si) bonds. However, the present inventors believe the “metal-rich” domains are such that the amount of metal to metal links (M1-O-M1, M1-O-M2, M2-O-M2) are minimized so as to prevent the formation of metal aggregates or particles of sufficient size to prevent their solubility in aromatic hydrocarbons, as discussed above.

Alternatively, the metal rich domain may not be of sufficient size to be observed using high resolution transmission electron micrograph (TEM). Thus in certain embodiments, the M1 and M2 metals are sufficiently distributed in the polyheterosiloxane compositions and have a domain size smaller than 10 nanometers, alternatively smaller than 5 nanometers, or alternatively smaller than 2 nanometers (detection limits for the TEM).

The present polyheterosiloxane compositions may be prepared by the methods as taught in PCT application No. PCT/US10/40510, which is incorporated by reference. The present polyheterosiloxanes may be prepared by reacting (A′) at least one metal (M1) alkoxide containing Ti, Zr, or Zn, (B′) at least one hydrolyzable metal (M2) salt selected from a non-lanthanide metal series of the Periodic Table, and (C′) at least one silicon-containing material, with an amount of water that provides between 50 and 200% necessary to hydrolyze and condense the alkoxy groups and other hydrolyzable groups on Components (A′), (B′), and (C′), to form the present polyheterosiloxane compositions.

Component (A′) comprises at least one metal alkoxide containing Ti, Zr, or Zn. The metal alkoxide may be selected from metal alkoxides having a general formula (I) R¹ₘM1OₙXₚ(OR²)ᵥ₁₋ₘ₋ₚ₋₂ₙ, where M1 is selected from Ti, Zr, and Zn, each X is independently selected from carboxylate ligands, organosulfonate ligands, organophosphate ligands, β-diketonate ligands, and chloride ligands, subscript v1 is the oxidation state of M1, m is a value from 0 to 3, n is a value from 0 to 2, p is a value from 0 to 3, each R¹ is a monovalent alkyl group having from 1 to 18 carbon atoms, each R² is an independently selected monovalent alkyl group having from 1 to 6 carbon atoms, aryl group having from 6 to 8 carbon atoms, or a polyether group having a general formula (VI) —(R³O)_{q}R⁴, where q is a value from 1 to 4, each R³ is an independently selected divalent alkylene group having from 2 to 6 carbon atoms, R⁴ is an independently selected hydrogen atom or monovalent alkyl group having from 1 to 6 carbon atoms.

In Formula (I), R¹ is a monovalent alkyl group having from 1 to 18 carbon atoms. Examples of the alkyl group of R¹ include methyl, ethyl, propyl, isopropyl, butyl, t-butyl, hexyl, octyl, decyl, dodecyl, hexadecyl, and octadecyl. Alternatively, the alkyl group comprises 1 to 8 carbon atoms. Alternatively, the alkyl group is methyl, ethyl, propyl, butyl, hexyl, and octyl.

In Formula (I), each R² is an independently selected monovalent alkyl group having from 1 to 6 carbon atoms, aryl group having from 6 to 8 carbon atoms, or a polyether group having a general formula (VI) —(R³O)_{q}R⁴, where q is a value from 1 to 4, each R³ is an independently selected divalent alkylene group having from 2 to 6 carbon atoms, R⁴ is an independently selected hydrogen atom or monovalent alkyl group having from 1 to 6 carbon atoms.

Examples of the alkyl groups of R² include methyl, ethyl, propyl, isopropyl, butyl, t-butyl, and hexyl. Examples of the aryl groups of R² include phenyl and benzyl.

Examples of the divalent alkylene group having from 2 to 6 carbon atoms of R³ include —CH₂CH₂— and —CH₂CH(CH₃)—. Examples of the alkyl groups having from 1 to 6 carbon atoms of R⁴ are as described above for R². Subscript q in Formula (VI) is a value from 1 to 4, alternatively 1 to 2. Examples of the polyether group of Formula (VI) include methoxyethyl, methoxypropyl, methoxybutyl, ethoxyethyl, ethoxypropyl, ethoxybutyl, methoxyethoxyethyl, and ethoxyethoxyethyl.

Alternatively, R² is an alkyl group having from 1 to 6 carbon atoms, alternatively ethyl, propyl, and butyl, alternatively propyl and butyl.

In Formula (I), X is selected from carboxylate ligands, organosulfonate ligands, organophosphate ligands, β-diketonate ligands, and chloride ligands, alternatively carboxylate ligands and β-diketonate ligands. The carboxylate ligands useful for X have a formula R¹⁵COO— where R¹⁵ is selected from hydrogen, alkyl groups, alkenyl groups, and aryl groups. Examples of useful alkyl groups for R¹⁵ include alkyl groups having from 1 to 18 carbon atoms, alternatively 1 to 8 carbon atoms as described above for R¹. Examples of useful alkenyl groups for R¹⁵ include alkenyl groups having from 2 to 18 carbon atoms, alternatively 2 to 8 carbon atoms such as vinyl, 2-propenyl, allyl, hexenyl, and octenyl. Examples of useful aryl groups for R¹⁵ include aryl groups having from 6 to 18 carbon atoms, alternatively 6 to 8 carbon atoms such as phenyl and benzyl. Alternatively R¹⁵ is methyl, 2-propenyl, allyl, and phenyl. The β-diketonate ligands useful for X can have the following structures:

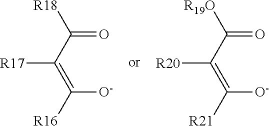

where R¹⁶, R¹⁸, and R²¹ are selected from monovalent alkyl and aryl groups. Examples of useful alkyl groups for R¹⁶, R¹⁸, and R²¹ include alkyl groups having from 1 to 12 carbon atoms, alternatively 1 to 4 carbon atoms such as methyl, ethyl, trifluoromethyl, and t-butyl. Examples of useful aryl groups for R¹⁶, R¹⁸, and R²¹ include aryl groups having from 6 to 18 carbon atoms, alternatively 6 to 8 carbon atoms such as phenyl and tolyl. R¹⁹ is selected from alkyl groups, alkenyl groups and aryl groups. Examples of useful alkyl groups for R¹⁹ include C1 to C18 alkyl groups, alternatively C1 to C8 alkyl groups such as methyl, ethyl, propyl, hexyl and octyl. Examples of useful alkenyl groups for R¹⁹ include alkenyl groups having from 2 to 18 carbon atoms, alternatively C2 to C8 carbon atoms such as allyl, hexenyl, and octenyl. Examples of useful aryl groups for R¹⁹ include aryl groups having from 6 to 18 carbon atoms, alternatively 6 to 8 carbon atoms such as phenyl and tolyl. R¹⁷ and R²⁰ are hydrogen or alkyl, alkenyl, and aryl groups. Examples of useful alkyl groups for R¹⁷ and R²⁰ include alkyl groups having from 1 to 12 carbon atoms, alternatively 1 to 8 carbon atoms such as methyl and ethyl. Examples of useful alkenyl groups for R¹⁷ and R²⁰ include alkenyl groups having from 2 to 18 carbon atoms, alternatively 2 to 8 carbon atoms such as vinyl, allyl, hexenyl, and octenyl. Examples of useful aryl groups for R¹⁷ and R²⁰ include aryl groups having from 6 to 18 carbon atoms, alternatively 6 to 8 carbon atoms such as phenyl and tolyl. R¹⁶, R¹⁷, R¹⁸, R¹⁹, R²⁰, and R²¹ are each independently selected and can be the same or different.

In Formula (I), subscript v1 is the oxidation state of M1, ranging from 1 to 7. Alternatively, v1 ranges from 1 to 5.

In Formula (I), subscript m is a value from 0 to 3, alternatively 0 to 2, alternatively 0.

In Formula (I), subscript n is a value from 0 to 2, alternatively 0 to 1, alternatively 0.

In Formula (I), subscript p is a value from 0 to 3, alternatively 0 to 2, alternatively 0.

Examples of the metal alkoxides described by Formula (I) useful in the present method include titanium tetrapropoxides, titanium tetrabutoxides, zirconium tetrapropoxides, and zirconium tetrabutoxides from DuPont, aluminum tripropoxides, titanium ethoxide, titanium 2-ethylhexoxide, titanium methoxide, titanium methoxypropoxide, titanium n-nonyloxide, zinc methoxyethoxide, zirconium ethoxide, zirconium 2-ethylhexoxide, zirconium 2-methyl-2-butoxide, and zirconium 2-methoxymethyl-2-propoxide, titanium allylacetoacetate triisopropoxide, titanium bis(triethanolamine)diisopropoxide, titanium chloride triisopropoxide, titanium dichloride diethoxide, titanium diisopropoxy bis(2,4-pentanedionate), titanium diisopropoxide bis(tetramethylheptanedionate), titanium diisopropoxide bis(ethylacetoacetate), titanium methacrylate triisopropoxide, titanium methacryloxyethylacetoacetate triisopropoxide, titanium trimethacrylate methoxyethoxyethoxide, titanium tris(dioctylphosphato)isopropoxide, titanium tris(dodecylbenzenesulfonate)isopropoxide, zirconium (bis-2,2′-(alloxymethyl)-butoxide)tris(dioctylphosphate), zirconium diisopropoxide bis(2,2,6,6-tetramethyl-3,5-heptanedionate), zirconium dimethacrylate dibutoxide, zirconium methacryloxyethylacetoacetate tri-n-propoxide.

In one embodiment, component (A′) is selected from titanium tetraisopropoxide, titanium tetrabutoxide, or zirconium tetrabutoxide.

Alternatively, component (A′) may be selected from a polymer resulting from the partial hydrolysis and condensation of the metal alkoxides as described above. In this embodiment, component (A′) may be a butyl titanate polymer (such as DuPont TYZOR® BTP), propyl titanate polymer, iso-propyl titanate polymer, sec-butyl titanate polymer, tert-butyl titanate polymer, or zirconate polymers with similar substituents.

Component (B′) may comprise at least one metal (M2) salt selected from (B′1) a non-hydrated metal salt having a general formula (IV) R⁷ₑM2(Z)_{(v2-e)/w} or (B′2) a hydrated metal salt having a general formula (V) M2(Z)_{v2/w}.xH₂O, where M2 is selected from Zn, Cu, Bi, or Ag, v2 is the oxidation state of M2, w is the oxidation state of ligand Z where Z is independently chosen from carboxylates, β-diketonates, fluoride, chloride, bromide, iodide, organic sulfonate, nitrate, nitrite, sulphate, sulfite, cyanide, phosphites, phosphates, organic phosphites, organic phosphates, and oxalate, each R⁷ is an independently selected alkyl group having 1 to 18 carbon atoms, alkenyl group having from 2 to 8 carbon atoms, or aryl group having from 6 to 8 carbon atoms, e is a value from 0 to 3 and x is a value from 0.5 to 12 and describes the average number of H₂O molecules associated with each metal salt molecule.

In Formulas (IV) and (V), the metal element described by M2 is selected from any of the non-lanthanide metals in the Periodic Table of Elements. Alternatively, M2 is Zn, Ag or a combination of both.

In Formulas (IV) and (V), subscript v2 is the oxidation state of M2 and can range from 1 to 7, alternatively 1 to 4.

In Formulas (IV) and (V), subscript w is the oxidation state of ligand Z and can range from 1 to 3, alternatively 1 to 2.

The Z group in Formulas (IV) and (V) describes the various counter ligands attached to the metal element (M2). Generally, each Z is independently selected from carboxylate ligands, β-diketonate ligands, fluoride ligand, chloride ligand, bromide ligand, iodide ligand, organic sulfonate ligands, nitrate ligand, nitrite ligand, sulphate ligand, sulfite ligand, cyanide ligand, phosphate ligand, phosphite ligand, organic phosphite ligands, organic phosphate ligands, and oxalate ligand.

The carboxylate ligands and β-diketonate ligands useful for Z are as described above for X.

The organic sulfonate ligands useful for Z have a formula R²²SO₃^{-, where R}²² is selected from monovalent alkyl groups, alkenyl groups and aryl groups. Examples of useful alkyl groups, alkenyl groups and aryl groups are as described above for R¹⁵. Alternatively R²² is tolyl, phenyl, and methyl.

The organic phosphate ligands useful for Z have a formula (R²³O)₂PO₂^{- or R}²³O—PO₃²⁻, where R²³ is selected from monovalent alkyl groups, alkenyl groups and aryl groups. Examples of useful alkyl groups, alkenyl groups and aryl groups are as described above for R¹⁵. Alternatively R²³ is phenyl, butyl, and octyl.

The organic phosphite ligands useful for Z have a formula (R²⁴O)₂PO⁻ or R²⁴O—PO₂²⁻—, where R²⁴ is selected from monovalent alkyl groups, alkenyl groups and aryl groups. Examples of useful alkyl groups, alkenyl groups and aryl groups are as described above for R¹⁵. Alternatively R²⁴ is phenyl, butyl, and octyl.

Alternatively, Z in Formulas (IV) and (V) is independently selected from carboxylate ligands, β-diketonate ligands, nitrate ligand, sulphate ligand, and chloride ligand. Alternatively, Z includes carboxylate ligands and β-diketonate ligands.

In Formulas (IV) and (V), subscript e is a value from 0 to 3, alternatively 0 to 2, alternatively 0.

In Formula (IV), R⁷ is an independently selected alkyl group having 1 to 18 carbon atoms, alkenyl group having from 2 to 8 carbon atoms, or aryl group having from 6 to 8 carbon atoms. Examples of R⁷ are as described above for R⁵.

In Formula (V), x is a value from 0.5 to 12, alternatively 1 to 9.

Examples of (B′) metal salts described by Formula (IV) useful in the present method include but are not limited to zinc acetate, zinc acrylate, zinc benzoate, zinc 2-ethylhexoate, silver nitrate, silver benzoate, silver 2-ethylhexanoate, silver neodecanoate, copper acetate, copper acrylate, copper benzoate, copper 2-ethylhexoate, bismuth 2-ethylhexanoate, bismuth neodecanoate, bismuth acetate, and bismuth salicylate.

Examples of hydrated metal salts (B′2) described by Formula (VI) useful in the present method include the hydrated versions of any of the metal salts as listed above for (B′1).

In one embodiment, (B′) is zinc acetate, silver nitrate, or a combination of both.

Both the non-hydrated metal salts and the hydrated metal salts described above are commercially available through the major chemical vendors, such as Sigma-Aldrich, Fisher Scientific, Alfa-Aesar, Gelest.

Component (C′) is a silicon-containing material having hydrolyzable groups selected from (C′1) an organosiloxane, or (C′2) a silane. In one embodiment, component (C′) is at least one silicon-containing material selected from (C′1) an organosiloxane having an average formula (II) R⁵_{g}(R⁶O)_{f}SiO_{(4-(f+g))/2} or (C′2) a silane having a general formula (III) R⁵ₕSiZ′ᵢ, where Z′ is Cl or OR⁶, each R⁵ is an independently selected hydrogen atom, alkyl group having 1 to 18 carbon atoms, alkenyl group having from 2 to 18 carbon atoms, aryl group having from 6 to 12 carbon atoms, epoxy group, amino group, or carbinol group, providing at least one R⁵ groups on the (C′1) organosiloxane or (C′2) silane selected to produce the present polyheterosiloxane composition is an R′ group, as defined above for the R′₂SiO_{2/2} or R′SiO_{3/2} siloxy units. In other words, at least one R⁵=R′ in the (C′1) organosiloxane or (C′2) silane component as described by formula (II) or (III). Each R⁶ is an independently selected hydrogen atom or alkyl group having from 1 to 6 carbon atoms, aryl group having from 6 to 8 carbon atoms, or a polyether group having a general formula (VI) —(R³O)_{q}R⁴, where q is a value from 1 to 4, each R³ is an independently selected divalent alkylene group having from 2 to 6 carbon atoms, R⁴ is an independently selected hydrogen atom or monovalent alkyl group having from 1 to 6 carbon atoms, the subscript f is a value from 0.1 to 3, g is a value from 0.5 to 3, and (f+g) is a value from 0.6 to 3.9, h is a value from 0 to 3, i is a value from 1 to 4 and (h+i) equals 4.

The alkyl groups having 1 to 18 carbon atoms of R⁵ in Formulas (II) and (III) are as described above for R¹. Alternatively, the alkyl group comprises 1 to 6 carbon atoms; alternatively, the alkyl group is methyl, ethyl, propyl, butyl, and hexyl.

The alkenyl groups having from 2 to 18 carbon atoms of R⁵ in Formulas (II) and (III) are illustrated by vinyl, propenyl, butenyl, pentenyl, hexenyl, or octenyl. Alternatively, the alkenyl group comprises 2 to 8 carbon atoms. Alternatively, the alkenyl group is vinyl, allyl, and hexenyl.

The aryl groups having 6 to 12 carbon atoms of R⁵ in Formulas (II) and (III) are illustrated by phenyl, naphthyl, benzyl, tolyl, xylyl, methylphenyl, 2-phenylethyl, 2-phenyl-2-methylethyl, chlorophenyl, bromophenyl and fluorophenyl. Alternatively, the aryl group comprises 6 to 8 carbon atoms. Alternatively, the aryl group is phenyl.

In Formula (II), subscript f is a value from 0.1 to 3, alternatively 1 to 3.

In Formula (II), subscript g is a value from 0.5 to 3, alternatively 1.5 to 2.5.

In Formula (II), subscripts (f+g) have a value from 0.6 to 3.9, alternatively 1.5 to 3.

Examples of the organosiloxanes (C′1) described by Formula (II) and useful in the present method include oligomeric and polymeric organosiloxanes, such as silanol-terminated polydimethylsiloxane, polymethylmethoxysiloxane, polysilsesquioxane, alkoxy and/or silanol containing MQ resin, and combinations thereof. They are made by hydrolysis of the corresponding organomethoxysilanes, organoethoxysilanes, organoisopropoxysilanes, and organochlorosilanes.

In Formula (III), each Z′ is a chloro atom (Cl) or OR⁶, where R⁶ is as described above. Alternatively, Z′ is OR⁶.

In Formula (III), subscript h is a value from 0 to 3, alternatively, h is a value from 1 to 3, alternatively, from 2 to 3.

In Formula (III), subscript i is a value from 1 to 4, alternatively i is a value from 1 to 3, alternatively, from 1 to 2.

In Formula (III), subscripts (h+i) equal 4.

Examples of the silanes (C′2) described by Formula (III) include methyltrichlorosilane, phenyltrichlorosilane, dimethyldichlorosilane, phenylmethyldichlorosilane, methyltrimethoxysilane, phenyltrimethoxysilane, dimethyldimethoxysilane, phenylmethyldimethoxysilane, phenylsilanetriol, diphenylsilanediol, phenylmethylsilanediol, dimethylsilanediol, trimethylsilanol, triphenylsilanol, phenyldimethoxysilanol, phenylmethoxysilanediol, methyldimethoxysilanol, methylmethoxysilanediol, phenyldiethoxysilanol, phenylethoxysilanediol, methyldiethoxysilanol, methylethoxysilanediol.

In one embodiment of the present method for preparing the present polyheterosiloxane compositions Component (A′) and Component (B′) are reacted with water to form a mixed metal oxides solution containing M1-O-M2 oxo-linkages, and (2) then further reacting the mixed metal oxides solution with Component (C′1) or (C′2) to form the polyheterosiloxane composition, wherein the total amount of water added is between 50 and 200% of the amount theoretically necessary for the hydrolysis and condensation of all alkoxy groups and other hydrolyzable groups on Components (A′), (B′), and (C′).

An amount of water must be added in each embodiment so that polyheterosiloxanes having at least two non-Si metal elements are formed. Since water can also be incorporated via the hydrated metal salts (B′2), a person skilled in the art would understand that when hydrated metal salts are utilized either smaller amounts or no additional amounts of water may need to be added in order for the needed amount of water to be present. Generally, the amount of water needed for making the present polyheterosiloxanes ranges from 50% to 200% of the theoretical amount of water necessary for complete hydrolysis and condensation of all the alkoxy and other hydrolyzable groups present on each of the components. A person skilled in the art would understand that 0.5 mole of water is necessary for hydrolysis and condensation of 1 mole of alkoxy and other hydrolyzable groups. Alternatively, the amount of water needed to make the present polyheterosiloxanes ranges from 70% to 150% of the theoretical amount of H₂O necessary for complete hydrolysis and condensation of all the alkoxy and other hydrolyzable groups present on each of the components, alternatively, 80% to 120% on the same basis. Typically, the water is added slowly to ensure the metal alkoxide does not react so quickly with the water as to form a precipitate. Alternatively, one method of accomplishing this is to dilute the water with solvents. The solvents useful for diluting the water are the same as used for dispersing the components. Depending on the components used and when they are added the needed water may also be added at one time or during one or more of the steps. Other hydrolyzable groups that may be present and need to be hydrolyzed and condensed are any found on the components used, including, but not limited to, chloro.

As used herein, the term “dispersion” in the present methods means that the molecules of the various components are homogenously distributed. Each of the components may be liquid or solids and so it is preferred that they are pre-mixed or dispersed. Stirring one or more of the components in a solvent is an excellent way to get a homogenous dispersion; or a solvent may not be needed if one or more components can be dispersed in another component. When solvents are used, any kind of solvent is useful including polar solvents, non-polar solvent, hydrocarbon solvents including aromatic and saturated hydrocarbons, alcohols. Examples of solvents useful for dispersing Components (A′), (B′), and (C′) includes hydrocarbonethanol, 1-propanol, isopropanol, 1-butanol, 2-butanol, methoxyethanol, methoxyethoxyethanol, butyl acetate, toluene, and xylene, alternatively isopropanol, 1-butanol, 2-butanol, and butyl acetate. One type of solvent could be used or a mixture of different solvents would also be useful. The dispersing or mixing may be done by any conventional means such as stirring.

Generally, the reaction between Components (A′), (B′), and (C′) in each of the methods proceeds at room temperature (20° C.) but if desired, elevated temperatures up to about 140° C. may be used. Alternatively, the temperature can range from 20° C. to 120° C. Generally, the reaction can take 30 minutes to 24 hours, alternatively 10 minutes to 4 hours. An optional step in all the methods comprises removing the solvent to produce the polyheterosiloxane. The solvents can be removed by any conventional manner such as heating to elevated temperatures or using reduced pressure. The polyheterosiloxane can then be redispersed in a solvent of choice such as toluene, THF, butyl acetate, chloroform, dioxane, 1-butanol, and pyridine. Since the Si—O-M linkages made by the present method can be susceptible to hydrolytic cleavage in the presence of H₂O, to ensure longer shelf life it is preferred to minimize the polyheterosiloxane's exposure to moisture.

The present disclosure further provides a method for forming an antimicrobial coating comprising:
I) forming a film containing the present polyheterosiloxane compositions, and
II) heating the film to form a cured coating.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %. All measurements were conducted at 23° C. unless indicated otherwise.

### Example 1

14.50 g ZnAc₂.2H₂O, 61.11 g BTP, 20 g 1-BuOH, and 60 g toluene were charged to a 1 liter flask. A clear solution was obtained after the mixture was stirred at RT for at least 2 hours. 34.45 g Ph₂Si(OMe)₂ was added into the flask. Under stirring a solution containing 8.80 g 0.1M HCl and 79.2 g 1-BuOH was added into the flask slowly. After stirring at RT for 50 minutes the solution was heated to 90° C. for 15 minutes and turned translucent. Then the solution was cool to ˜40° C. A solution containing 0.79 g 0.1M HCl and 7.1 g 1-BuOH was added to the flask quickly. Total amount of H₂O was 145%. The solution was heated to 90° C. again for 28 minutes. Then ˜69 g solvent was distilled off. The solution was translucent after cooling to RT. Finally the solvents were removed using a rotary evaporator. The white solid with a composition of Ti_{0.56}Zn_{0.14}D^{Ph2}_{0.30} was dissolved in butyl acetate at 45 wt %.

### Example 2

68.4 g of tetrabutyl titanate (TnBT), 21.0 g 1-BuOH, 20.2 g toluene, and 6.43 g AgNO₃ were mixed in a 500 ml flask. Stirred at RT for ˜2 hours and then added 43.2 g solution containing 10% 0.1N HCl in 1-BuOH. Continued stirring for 1.5 hours at RT. Added a prehydrolyzed siloxane solution that was prepared by mixing 28.50 g dimethyldimethoxysilane and 8.60 g 0.05N HNO₃ and sonicating the mixture for 10 minutes. After stirring at RT for 3 hours, the solution was filtered through a glass wool filled funnel to remove small amount of precipitation. After addition of 144 g toluene, ˜½ of the solvents was removed by a rotary evaporation apparatus. A dark brown solution was obtained. The composition was Ti_{0.42}Ag_{0.08}D^{Me2}_{0.50}.

### Example 3

78.2 g TnBT, 36.0 g 1-BuOH, and 41.3 g toluene were mixed in a 500 ml flask. Under stirring a mixture containing 1.93 g AgNO₃, 3.27 g 0.1N HNO₃, and 29.43 g 1-BuOH was added into the flask. Stirred at RT for 50 minutes and formed a dark brown solution. Then 9.98 g ZnAc₂.2H₂O and 12 g toluene was added into the flask. Stirred at RT for 1 hour. Added a prehydrolyzed siloxane solution that was prepared by mixing 34.1 g dimethyldimethoxysilane, 11.0 g 0.05N HNO₃, and 20.0 g toluene and sonicating the mixture for 10 minutes. After stirring at RT for 3 hours, the solution was filtered through a glass wool filled funnel to remove small amount of precipitation. Solvents were removed by a rotary evaporation apparatus. The product was dissolved in butyl acetate with 40 wt %. A dark brown solution was obtained. The composition was Ti_{0.40}Ag_{0.02}Zn_{0.08}D^{Me2}_{0.50}.

### Example 4

88.9 g TnBT, 25.0 g 1-BuOH, 50.0 g toluene, and 14.20 g ZnAc₂.2H₂O were mixed in a 500 ml flask and stirred overnight. 47.0 g solution containing 10% 0.1N HCl in 1-BuOH was added into the flask and continued stirring for 70 minutes at RT. Added a prehydrolyzed siloxane solution that was prepared by mixing 38.8 g dimethyldimethoxysilane and 10.45 g 0.02 N HCl and sonicating the mixture for 10 minutes. After stirring at RT for 6 hours, solvents were removed by a rotary evaporation apparatus. The product was dissolved in butyl acetate with 48 wt %. A clear solution was obtained. The composition was Ti_{0.40}Zn_{0.10}D^{Me2}_{0.50}.

1. A polyheterosiloxane composition comprising at least 70% by weight of:
(A) a first metal (M1) selected from Ti, Zr, or Zn,
(B) a second metal (M2) selected from Zn, Cu, Bi, or Ag
with the proviso that the second metal is not the same as the first metal,
(C) siloxy units having the formula R¹₂SiO_{2/2} or R¹SiO_{3/2}
where R¹ is independently a hydrocarbon group or halogen substituted hydrocarbon group containing 1 to 30 carbon atoms,
wherein;
the mole fraction of components (A), (B), and (C) in the polyheterosiloxane composition relative to each other is of the formula [M1]ₐ[M2]_{b}[R¹₂SiO_{2/2}]_{c} [R¹SiO_{3/2}]_{d}
where
a may vary from 0.10 to 0.7,
b may vary from 0.001 to 0.5,
c may vary from zero to 0.9,
d may vary from zero to 0.9,
with the provisos that c and d both cannot be zero, and the sum of a+b+c+d≈1,
the polyheterosiloxane composition is soluble in an aromatic hydrocarbon solvent.

2. The polyheterosiloxane composition of claim 1 wherein the first metal M1 is Ti.

3. The polyheterosiloxane composition of claim 2 wherein the second metal M2 is Zn, Ag or a combination of both.

4. The polyheterosiloxane composition of claim 1 wherein at least one of the R¹ groups is phenyl.

5. The polyheterosiloxane composition of claim 1 wherein the siloxy units have the formula [(C₆H₅)SiO_{3/2} ]_{d}.

6. A method for preparing the polyheterosiloxane compositions of claim 1 comprising reacting:
(A′) a metal (M1) alkoxide containing Ti, Zr, or Zn,
(B′) a hydrolyzable metal (M2) salt containing Zn, Cu, Bi, or Ag,
with the proviso that the second metal is not the same as the first metal and
(C′) a silicon-containing material having hydrolyzable groups selected from (C′1) an organosiloxane, or (C′2) a silane,
with an amount of water that provides between 50 and 200% necessary to hydrolyze and condense the alkoxy groups and other hydrolyzable groups on Components (A′), (B′), and (C′), to form the present polyheterosiloxane compositions.

7. The method of claim 6 wherein Component (A′) and Component (B′) are reacted with water to form a mixed metal oxides solution containing M1-O-M2 oxo-linkages, and then further reacting the mixed metal oxides solution with Component (C′1) or (C′2) to form the polyheterosiloxane composition, wherein the total amount of water added is between 50 and 200% of the amount theoretically necessary for the hydrolysis and condensation of all alkoxy groups and other hydrolyzable groups on Components (A′), (B′), and (C′).

8. A method for forming an antimicrobial coating comprising:
I) forming a film containing a polyheterosiloxane composition comprising at least 70% by weight of:
(A) a first metal (M1) selected from Ti, Zr, or Zn,
(B) a second metal (M2) selected from Zn, Cu, Bi, or Ag,
with the proviso that the second metal is not the same as the first metal,
(C) siloxy units having the formula R¹₂SiO_{2/2} or R¹SiO_{3/2}
where R¹ is independently a hydrocarbon group or halogen substituted hydrocarbon group containing 1 to 30 carbon atoms,
wherein;
the mole fraction of components (A), (B), and (C) in the polyheterosiloxane composition relative to each other is of the formula [M1]ₐ[M2]_{b}[R¹₂SiO_{2/2}]_{c} [R¹Si_{3/2}]_{d}
where
a may vary from 0.10 to 0.7,
b may vary from 0.001 to 0.5,
c may vary from zero to 0.9,
d may vary from zero to 0.9,
with the provisos that c and d both cannot be zero, and the sum of a+b+c+d≈1,
the polyheterosiloxane composition is soluble in an aromatic hydrocarbon solvent and
II) heating the film to form a cured coating.

9. The method of claim 8 wherein the first metal M1 is Ti.

10. The method of claim 9 wherein the second metal M2 is Zn, Ag or a combination of both.

11. The method of claim 8 wherein at least one of the R¹ groups is phenyl.

12. The method of claim 8 wherein the siloxy units have the formula [(C₆H₅)SiO_{3/2}]_{d}.

13. An antimicrobial coating prepared by the method of claim 8.

14. The antimicrobial coating of claim 13 wherein the first metal M1 is Ti.

15. The antimicrobial coating of claim 14 wherein the second metal M2 is Zn, Ag or a combination of both.

16. The antimicrobial coating of claim 13 wherein at least one of the R¹ groups is phenyl.
